(19) United States
(12) Patent Application Publication
(10) Pub. No.: US 2025/0154048 A1
(43) Pub. Date: May 15, 2025

(54) OPTICAL GLASS, PREFORM FOR PRECISION PRESS MOLDING, AND OPTICAL ELEMENT

(71) Applicant: Sumita Optical Glass, Inc., Saitama-shi, Saitama (JP)

(72) Inventor: Mao ARAKI, Saitama-shi, Saitama (JP)

(73) Assignee: Sumita Optical Glass, Inc., Saitama-shi, Saitama (JP)

(21) Appl. No.: 18/726,362

(22) PCT Filed: Dec. 22, 2022
(86) PCT No.: PCT/JP2022/047425

§ 371 Date: Jul. 2, 2024

(30) Foreign Application Priority Data
Jan. 12, 2022 (JP) 2022-003347

(51) Int. Cl. C03C 3/068

(52) U.S. Cl. CPC C03C 3/068

(57) ABSTRACT

Provided is an optical glass that in addition to having a high refractive index and low dispersion, also has a low glass-transition temperature and can suppress temperature dependence of image formation. The optical glass has a composition containing, by mass %, 1% to 15% of SiO₂, 10% to 25% of B₂O₃, 1% to 5% of Li₂O, 5% to 30% of CaO, 10% or less of BaO, 8% or less of Nb₂O₅, 0% to 8% of ZrO₂, 8% or less of TiO₂, 10% or less of Y₂O₃, 5% to 20% of La₂O₃, 15% or less of Gd₂O₃, 8% or less of Ta₂O₅, and 8% or less of WO₃, and does not substantially contain ZnO. A molar ratio (R/F) of contents related to 10 specific components is 0.8 to 2.0, and a temperature coefficient (40° C. to 60° C.) of relative refractive index is −5.0×10⁻⁶° C.⁻¹ to 3.0×10⁻⁶° C.⁻¹.

### TECHNICAL FIELD

The present disclosure relates to an optical glass, a preform for precision press molding, and an optical element.

### BACKGROUND

The spread and development of optical devices had been accompanied by demand for optical glasses having various characteristics. In particular, with vehicle-mounted optical devices, surveillance cameras, and so forth in mind, there has been even greater demand for optical glasses that enable the achievement of compactization and enhanced performance of products in recent years.

The use of high refractive index glass (for example, glass having a refractive index (nd) of 1.70 or higher) and optical design using aspheric lenses through precision press molding or the like are essential elements for achieving such compactization and enhanced performance of products.

Since a high refractive index glass generally has high wavelength dispersion and tends to easily result in chromatic aberration, it is normally necessary to combine the high refractive index glass with a low dispersion glass in order to correct chromatic aberration. However, increasing the number of pieces of glass (lenses) that are combined tends to be disadvantageous for achieving compactization. Therefore, the use of an optical glass having a high refractive index while also having low dispersion (refractive index (nd): approximately 1.70 to 1.80; Abbe number (vd): approximately 40 to 55) is expected to enable reduction of the number of lenses and compactization. In other words, there is a need for an optical glass having a high refractive index and low dispersion such as described above.

In addition, an optical glass (lens) that is used in a projector, a vehicle-mounted optical device, or like may be exposed to extreme changes of environmental temperature and thus should preferably experience little negative effect on image formation and like in response to temperature change. With regard to this point, a high refractive index glass such as described above tends to have a large positive change of refractive index with respect to temperature. Therefore, it is desirable to select a glass having little change or a large negative change of refractive index with respect to temperature as such high refractive index glass and to suppress temperature dependence of refractive index as much as possible.

As one example of an optical glass having a high refractive index and low dispersion, Patent Literature (PTL) 1 discloses an optical glass that has a specific B₂O₃—La₂O₃—Gd₂O₃—ZnO-based composition and that has optical constants of a refractive index (nd) of 1.72 to 1.83 and an Abbe number (vd) of 45 to 55.

However, the optical glass described in PTL 1 contains large amounts of B₂O₃ and rare earth element compounds such as La₂O₃ in order to achieve a high refractive index and low dispersion and essentially has a high glass-transition temperature (Tg) that at its lowest is still approximately 580° C., which makes this optical glass disadvantageous for producing an aspheric lens by precision press molding.

On the other hand, PTL 2 discloses an optical glass that has a specific SiO₂—B₂O₃—La₂O₃—Gd₂O₃—ZnO-based composition, a refractive index (nd) of 1.65 to 1.77, an Abbe number (vd) of 40 to 55, and a glass-transition temperature (Tg) of 550° C. or lower.

### CITATION LIST

### Patent Literature

PTL 1: JP2006-315954A
PTL 2: JP2006-111482A

### SUMMARY

### Technical Problem

However, the optical glass described in PTL 2 contains a large amount of ZnO in order to lower the glass-transition temperature (Tg), has a large positive change of refractive index, and may experience significant deterioration of image formation depending on temperature change.

The presently disclosed matter was developed in light of the circumstances described above, and one object of the present disclosure is the provision of an optical glass that in addition to having a high refractive index and low dispersion, also has a low glass-transition temperature and can suppress temperature dependence of image formation. Another object of the present disclosure is the provision of a preform for precision press molding and an optical element in which the aforementioned optical glass is used.

### Solution to Problem

The inventor discovered as a result of diligent and extensive studies to achieve the objects set forth above that by setting SiO₂, B₂O₃, Li₂O, CaO, and La₂O₃ as a fundamental composition and by optimizing a molar ratio (R/F) of contents related to specific components, it is possible to obtain an optical glass that has a smaller or more negative change of refractive index (n) with respect to temperature (T) (temperature coefficient of relative refractive index (dn/dT)), that can suppress temperature dependence of image formation, and that also has a low glass-transition temperature.

Specifically, an optical glass according to the present disclosure comprises a composition containing, by mass %:
not less than 1% and not more than 15% of SiO₂;
not less than 10% and not more than 25% of B₂O₃;
not less than 1% and not more than 5% of Li₂O;
not less than 5% and not more than 30% of CaO;
not less than 0% and not more than 10% of BaO;
not less than 0% and not more than 8% of Nb₂O₅;
not less than 0% and not more than 8% of ZrO₂;
not less than 0% and not more than 8% of TiO₂;
not less than 0% and not more than 10% of Y₂O₃;
not less than 5% and not more than 20% of La₂O₃;
not less than 0% and not more than 15% of Gd₂O₃;
not less than 0% and not more than 8% of Ta₂O₅; and
not less than 0% and not more than 8% of WO₃, wherein
the optical glass does not substantially contain ZnO,
R/F, where R is total content in mol % of Li₂O, CaO, and BaO and F is total content in mol % of SiO₂ and B₂O₃, is not less than 0.8 and not more than 2.0, and
a temperature coefficient of relative refractive index at a d-line of 587.562 nm for from 40° C. to 60° C. is not less than −5.0×10⁻⁶° C.⁻¹ and not more than 3.0×10⁻⁶° C.⁻¹.

This optical glass, in addition to having a high refractive index and low dispersion, also has a low glass-transition temperature and can suppress temperature dependence of image formation.

The optical glass according to the present disclosure preferably has a refractive index (nd) of not less than 1.70 and not more than 1.80 and an Abbe number (vd) of not less than 40 and not more than 55.

The optical glass according to the present disclosure preferably has a glass-transition temperature (Tg) of 560° C. or lower.

A preform for precision press molding according to the present disclosure comprises the optical glass set forth above as a material. This preform for precision press molding is easy to precision press mold and can be used to obtain a product having suppressed temperature dependence of image formation.

An optical element according to the present disclosure comprises the optical glass set forth above as a material. This optical element makes it possible to obtain a product having suppressed temperature dependence of image formation.

### Advantageous Effect

According to the present disclosure, it is possible to provide an optical glass that in addition to having a high refractive index and low dispersion, also has a low glass-transition temperature and can suppress temperature dependence of image formation. Moreover, according to the present disclosure, it is possible to provide a preform for precision press molding and an optical element in which the aforementioned optical glass is used.

### DETAILED DESCRIPTION

The following provides a specific description of the present disclosure using embodiments.

### (Optical Glass)

An optical glass of one embodiment of the present disclosure (hereinafter, also referred to as the “optical glass of the present embodiment”) has a composition containing, by mass %:
not less than 1% and not more than 15% of SiO₂;
not less than 10% and not more than 25% of B₂O₃;
not less than 1% and not more than 5% of Li₂O;
not less than 5% and not more than 30% of CaO;
not less than 0% and not more than 10% of BaO;
not less than 0% and not more than 8% of Nb₂O₅;
not less than 0% and not more than 8% of ZrO₂;
not less than 0% and not more than 8% of TiO₂;
not less than 0% and not more than 10% of Y₂O₃;
not less than 5% and not more than 20% of La₂O₃;
not less than 0% and not more than 15% of Gd₂O₃;
not less than 0% and not more than 8% of Ta₂O₅; and
not less than 0% and not more than 8% of WO₃, wherein
the optical glass does not substantially contain ZnO,
R/F, where R is the total content in mol % of Li₂O, CaO, and BaO and F is the total content in mol % of SiO₂ and B₂O₃, is not less than 0.8 and not more than 2.0, and
a temperature coefficient (40° C. to 60° C.) of relative refractive index at a d-line (587.562 nm) is not less than −5.0×10⁻⁶° C.⁻¹ and not more than 3.0×10⁻⁶° C.⁻¹.

Note that the optical glass of the present embodiment may contain other components (subsequently described) besides the above-described components (SiO₂, B₂O₃, Li₂O, CaO, BaO, Nb₂O₅, ZrO₂, TiO₂, Y₂O₃, La₂O₃, Gd₂O₃, Ta₂O₅, and WO₃). However, from a viewpoint of more reliably causing the expression of desired optical constants, lowering of glass-transition temperature, and suppression of temperature dependence of image formation, the content of such other components in the optical glass of the present embodiment is preferably 5 mass % or less, more preferably 3 mass % or less, and even more preferably 1 mass % or less. Moreover, it is particularly preferable that the optical glass of the present embodiment has a composition consisting of only the above-described components.

The phrase “consisting of only the above-described components” as used here encompasses a case in which impurity components other than the above-described components are unavoidably contained, and, more specifically, encompasses a case in which the proportion constituted by such impurity components is 0.2 mass % or less.

First, reasons for limiting the composition of the optical glass to the ranges set forth above in the present embodiment are described. Note that “%” used in relation to components means mass % unless otherwise specified (however, “%” used in relation to R/F means mol %).

### <SiO₂>

SiO₂ is an essential component in the optical glass of the present embodiment and is a component that forms a network structure serving as a framework of glass. Moreover, SiO₂ is a component that can increase devitrification resistance and chemical durability. However, when the content of SiO₂ in the optical glass is more than 15%, the refractive index is excessively lowered. Moreover, a SiO₂ content of more than 15% in the optical glass may excessively raise the glass-transition temperature (Tg) and yield temperature (At). On the other hand, glass formation becomes difficult when the content of SiO₂ in the optical glass is less than 1%. Therefore, the content of SiO₂ in the optical glass of the present embodiment is set as a range of not less than 1% and not more than 15%. From a similar viewpoint, the content of SiO₂ in the optical glass of the present embodiment is preferably 2% or more, and more preferably 3% or more, and is preferably 14% or less, and more preferably 13% or less.

<B₂O₃>

B₂O₃ is an essential component in the optical glass of the present embodiment and is a component that forms a network structure of glass. Moreover, B₂O₃ is an effective component for improving devitrification resistance, glass homogeneity, and meltability. However, when the content of B₂O₃ in the optical glass is more than 25%, the refractive index is excessively lowered. Moreover, a B₂O₃ content of more than 25% in the optical glass may excessively raise the glass-transition temperature (Tg) and yield temperature (At). On the other hand, glass formation becomes difficult when the content of B₂O₃ in the optical glass is less than 10%. Therefore, the content of B₂O₃ in the optical glass of the present embodiment is set as a range of not less than 10% and not more than 25%. From a similar viewpoint, the content of B₂O₃ in the optical glass of the present embodiment is preferably 11% or more, and more preferably 12% or more, and is preferably 24% or less, and more preferably 23% or less.

### <Li₂O>

Li₂O is an essential component in the optical glass of the present embodiment and is an effective component for lowering the glass-transition temperature (Tg) and yield temperature (At) and for reducing the temperature coefficient of relative refractive index. However, chemical durability and devitrification resistance decrease when the content of Li₂O in the optical glass is more than 5%. On the other hand, sufficient lowering of the glass-transition temperature (Tg) is not possible when the content of Li₂O in the optical glass is less than 1%. Moreover, it may not be possible to sufficiently obtain an effect of reducing the temperature coefficient of relative refractive index when the content of Li₂O in the optical glass is less than 1%. Therefore, the content of Li₂O in the optical glass of the present embodiment is set as a range of not less than 1% and not more than 5%. From a similar viewpoint, the content of Li₂O in the optical glass of the present embodiment is preferably 1.5% or more, and more preferably 2% or more, and is preferably 4.5% or less, and more preferably 4% or less.

### <CaO>

CaO is an essential component in the optical glass of the present embodiment and is an effective component for reducing the temperature coefficient of relative refractive index and achieving a high refractive index. However, chemical durability and devitrification resistance decrease when the content of CaO in the optical glass is more than 30%. On the other hand, devitrification resistance decreases when the content of CaO in the optical glass is less than 5%. Moreover, it may not be possible to sufficiently obtain an effect of reducing the temperature coefficient of relative refractive index when the content of CaO in the optical glass is less than 5%. Therefore, the content of CaO in the optical glass of the present embodiment is set as a range of not less than 5% and not more than 30%. From a similar viewpoint, the content of CaO in the optical glass of the present embodiment is preferably 7% or more, and more preferably 9% or more, and is preferably 28% or less, and more preferably 26% or less.

### <BaO>

BaO is an effective component for reducing the temperature coefficient of relative refractive index. Moreover, BaO is also an effective component for achieving a high refractive index and improving meltability. However, chemical durability and devitrification resistance decrease when the content of BaO in the optical glass is more than 10%. Therefore, the content of BaO in the optical glass of the present embodiment is set as a range of not less than 0% and not more than 10%. From a similar viewpoint, the content of BaO in the optical glass of the present embodiment is preferably 9% or less, and more preferably 8% or less.

<Nb₂O₅>

Nb₂O₅ is an effective component for achieving a high glass refractive index and improving chemical durability. However, a Nb₂O₅ content of more than 8% in the optical glass may result in an undesirably high refractive index or an undesirable increase of dispersion (decrease of the Abbe number). Therefore, the content of Nb₂O₅ in the optical glass of the present embodiment is set as a range of not less than 0% and not more than 8%. From a similar viewpoint, the content of Nb₂O₅ in the optical glass of the present embodiment is preferably 7.5% or less, and more preferably 7% or less.

### <ZrO_{2>}

ZrO₂ is an effective component for achieving a high glass refractive index and improving chemical durability. However, a ZrO₂ content of more than 8% in the optical glass reduces devitrification resistance and may result in an undesirably high refractive index or an undesirable increase of dispersion (decrease of the Abbe number). Therefore, the content of ZrO₂ in the optical glass of the present embodiment is set as a range of not less than 0% and not more than 8%. From a similar viewpoint, the content of ZrO₂ in the optical glass of the present embodiment is preferably 7.5% or less, and more preferably 7% or less.

### <TiO₂>

TiO₂ is an effective component for achieving a high glass refractive index and improving chemical durability. However, a TiO₂ content of more than 8% in the optical glass reduces devitrification resistance and may result in an undesirably high refractive index or an undesirable increase of dispersion (decrease of the Abbe number). Therefore, the content of TiO₂ in the optical glass of the present embodiment is set as a range of not less than 0% and not more than 8%. From a similar viewpoint, the content of TiO₂ in the optical glass of the present embodiment is preferably 7.5% or less, and more preferably 7% or less.

<Y₂O₃>

Y₂O₃ is an effective component for achieving a high glass refractive index and improving chemical durability. However, devitrification resistance decreases when the content of Y₂O₃ in the optical glass is more than 10%. Therefore, the content of Y₂O₃ in the optical glass of the present embodiment is set as a range of not less than 0% and not more than 10%. From a similar viewpoint, the content of Y₂O₃ in the optical glass of the present embodiment is preferably 9.5% or less, and more preferably 9% or less.

<La₂O₃>

La₂O₃ is an essential component in the optical glass of the present embodiment and is a useful component for adjustment to desired optical constants (refractive index and Abbe number) according to the present disclosure. Moreover, La₂O₃ is also an effective component for improving chemical durability and reducing the temperature coefficient of relative refractive index. However, devitrification resistance decreases when the content of La₂O₃ in the optical glass is more than 20%. On other hand, it may not be possible to sufficiently increase the refractive index or it may be extremely difficult to obtain the desired optical constants even through adjustment of the amounts of other components within specific ranges when the content of La₂O₃ in the optical glass is less than 5%. Therefore, the content of La₂O₃ in the optical glass of the present embodiment is set as a range of not less than 5% and not more than 20%. From a similar viewpoint, the content of La₂O₃ in the optical glass of the present embodiment is preferably 7% or more, and more preferably 9% or more, and is preferably 19% or less, and more preferably 18% or less.

<Gd₂O₃>

Gd₂O₃ is an effective component for achieving a high glass refractive index, achieving low dispersion, improving chemical durability, and reducing the temperature coefficient of relative refractive index. However, devitrification resistance decreases when the content of Gd₂O₃ in the optical glass is more than 15%. Therefore, the content of Gd₂O₃ in the optical glass of the present embodiment is set as a range of not less than 0% and not more than 15%. From a similar viewpoint, the content of Gd₂O₃ in the optical glass of the present embodiment is preferably 14% or less, and more preferably 13% or less.

<Ta₂O₅>

Ta₂O₅ is an effective component for achieving a high glass refractive index and improving chemical durability. However, a Ta₂O₅ content of more than 8% in the optical glass reduces devitrification resistance and may result in an undesirable increase of dispersion (decrease of the Abbe number). Therefore, the content of Ta₂O₅ in the optical glass of the present embodiment is set as a range of not less than 0% and not more than 8%. From a similar viewpoint, the content of Ta₂O₅ in the optical glass of the present embodiment is preferably 7.5% or less, and more preferably 7% or less.

### <WO₃>

WO₃ is an effective component for achieving a high glass refractive index and improving chemical durability. However, a WO₃ content of more than 8% in the optical glass reduces devitrification resistance and may result in an undesirable increase of dispersion (decrease of the Abbe number). Therefore, the content of WO₃ in the optical glass of the present embodiment is set as a range of not less than 0% and not more than 8%. From a similar viewpoint, the content of WO₃ in the optical glass of the present embodiment is preferably 7.5% or less, and more preferably 7% or less.

### <R/F (Molar Ratio)>

R/F of the optical glass of the present embodiment, where R is the total content in mol % of Li₂O, CaO, and BaO and F is the total content in mol % of SiO₂ and B₂O₃, is required to be not less than 0.8 and not more than 2.0. The inventor discovered that by limiting the contents of components of ions of metals such as Li, Ca, and Ba while also optimizing R/F (molar ratio), the used amounts of La₂O₃, Gd₂O₃, and Y₂O₃ that include rare earth elements are reduced while also reducing the temperature coefficient of relative refractive index and obtaining optical glass having a low glass-transition temperature (Tg). Note that when R/F is more than 2.0, devitrification resistance of glass decreases, and it is no longer possible to obtain good quality glass.

Moreover, R/F of the optical glass of the present embodiment is preferably more than 0.9, and more preferably 1.0 or more from a viewpoint of further lowering the temperature coefficient of relative refractive index and the glass-transition temperature.

### <ZnO (Non-Contained Component)>

ZnO can lower the glass-transition temperature (Tg) and the yield temperature (At) but may make it impossible to restrict the temperature coefficient of relative refractive index to within a specific range in an optical glass that contains the above-described components. Therefore, the optical glass of the present embodiment does not substantially contain ZnO.

Note that the phrase “does not substantially contain” as used with respect to a given component in the present specification means that the given component is not intentionally contained.

### <Other Components>

The optical glass of the present embodiment can contain other components besides the above-described components so long as this does not result in deviation from the object. For example, the optical glass of the present embodiment can contain a small amount of Na₂O, K₂O, Cs₂O, MgO, SrO, Al₂O₃, Ga₂O₃, In₂O₃, GeO₂, Sb₂O₃, Bi₂O₃, P₂O₅, MoO₃, etc. (for example, an amount such that the total of such other components is 5 mass % or less in the optical glass).

Note that it is preferable that the optical glass of the present embodiment does not contain components such as PbO, TeO₂, As₂O₃, and CdO, for example, that have high environmental impact or a highly negative effect on the human body.

Next, various characteristics of the optical glass of the present embodiment are described.

### <Refractive Index (Nd) and Abbe Number (Vd)>

The optical glass of the present embodiment preferably has a high refractive index and low dispersion in order to respond to a specific need.

The refractive index (nd) of the optical glass of the present embodiment can, more specifically, be set as not less than 1.70 and not more than 1.80. Moreover, the refractive index (nd) of the optical glass of the present embodiment is more preferably 1.71 or more, and is more preferably 1.79 or less.

The Abbe number (vd) of the optical glass of the present embodiment can, more specifically, be set as not less than 40 and not more than 55. Moreover, the Abbe number (vd) of the optical glass of the present embodiment is more preferably 41 or more, and even more preferably 42 or more, and is more preferably 53 or less, and even more preferably 50 or less.

Note that adjustment of the refractive index (nd) and the Abbe number (vd) of the optical glass of the present embodiment can be performed, for example, by adjusting the contents of the above-described components as appropriate within specific ranges.

### <Temperature Coefficient of Relative Refractive Index (Dn/dT)>

The optical glass of the present embodiment is required to have a temperature coefficient (40° C. to 60° C.) of relative refractive index at a d-line (587.562 nm) of not less than −5.0×10⁻⁶° C.⁻¹ and not more than 3.0×10⁻⁶° C.⁻¹. As a result, the optical glass of the present embodiment promotes suppression of temperature dependence of image formation. In a situation in which the component composition of the optical glass is set as previously described while also setting the above-described temperature coefficient as less than −5.0×10⁻⁶° C.⁻¹, the minimum level of chemical durability for optical glass cannot be ensured. Moreover, in a situation in which the above-described temperature coefficient of the optical glass is more than 3.0×10⁻⁶° C.⁻¹, the optical glass has a large positive change of refractive index with respect to temperature and thus cannot sufficiently suppress temperature dependence of image formation. The temperature coefficient of the optical glass of the present embodiment is preferably −4.0×10⁻⁶° C.⁻¹ or more, and more preferably −3.5× 10⁻⁶° C.⁻¹ or more from a viewpoint of further increasing chemical durability. Moreover, the temperature coefficient of the optical glass of the present embodiment is preferably 2.7×10⁻⁶° C.⁻¹ or less, and more preferably 2.5×10⁻⁶° C.⁻¹ or less from a viewpoint of more effectively suppressing temperature dependence of image formation.

Note that adjustment of the temperature coefficient of the optical glass of the present embodiment can be performed, for example, by adjusting the contents of the above-described components as appropriate within specific ranges.

### <Glass-Transition Temperature (Tg)>

The optical glass of the present embodiment preferably has a glass-transition temperature (Tg) of 560° C. or lower. When the glass-transition temperature (Tg) of the optical glass is 560° C. or lower, the softening temperature also decreases, and it becomes easier to perform precision press molding, and particularly to produce an aspheric lens by precision press molding. From a similar viewpoint, the glass-transition temperature (Tg) of the optical glass of the present embodiment is more preferably 555° C. or lower, and even more preferably 550° C. or lower.

Note that adjustment of the glass-transition temperature (Tg) of the optical glass of the present embodiment can be performed, for example, by adjusting the contents of the above-described components as appropriate within specific ranges.

### <Production Method of Optical Glass>

Next, the production method of the optical glass of the present embodiment is described.

The optical glass of the present embodiment can be produced according to a conventional production method without any specific limitations on the production method thereof so long as the composition of components satisfies the ranges set forth above.

For example, oxides, hydroxides, carbonates, nitrates, etc. are first weighed out in specific proportions as materials for components that can be contained in the optical glass of the present embodiment and are thoroughly mixed to obtain a glass batch. Next, this batch is loaded into a melting vessel (for example, a crucible made of a precious metal such as platinum) that is not reactive with the glass materials and is heated and melted at 1000° C. to 1500° C. in an electric furnace. Thereafter, stirring is performed in a timely manner to promote homogenization and cause refining. The resultant is subsequently cast into a mold that is preheated to an appropriate temperature and is then slowly cooled inside of the electric furnace to relieve strain and thereby enable production of the optical glass of the present embodiment. Note that a small amount of a refining agent such as Sb₂O₃ (for example, an amount such as to be less than 2 mass % in the optical glass) can be added for bubble removal.

### (Preform for Precision Press Molding)

The following provides a specific description of a preform for precision press molding of one embodiment of the present disclosure (hereinafter, also referred to as the “preform of the present embodiment”).

The preform for precision press molding (precision press molding preform) is a preformed glass material that is to be used in a commonly known precision press molding method, that is, a glass preform that is to be heated and subjected to precision press molding.

Precision press molding is also referred to as molded optics molding as is commonly known and is a method in which an optical surface of an optical element that is to ultimately be obtained is formed through transfer of the shape of a molding surface of a press mold. Note that the term “optical surface” refers to a surface where light that is to be controlled is refracted, reflected, diffracted, input/output, etc. in an optical element. For example, a lens surface of a lens corresponds to such an optical surface.

A feature of the preform of the present embodiment is that the optical glass set forth above is used as a material. As a result of the preform of the present embodiment having the optical glass set forth above as a material in this manner, the preform of the present embodiment is easy to precision press mold and can be used to obtain a product having suppressed temperature dependence of image formation.

Note that from a viewpoint of more reliably obtaining the desired performance, it is preferable that the preform of the present embodiment satisfies the essential requirements relating to the composition of components that were previously described for the optical glass according to the present disclosure, and more preferable that the preform of the present embodiment satisfies the various preferable requirements that were previously described for the optical glass according to the present disclosure.

No specific limitations are placed on the method by which the preform of the present embodiment is produced. However, it is desirable that the preform of the present embodiment is produced by a production method described below so as to exploit the excellent characteristics of the optical glass.

A first method of producing the preform (referred to as a “preform production method I”) is a method in which the optical glass serving as material is melted, the resultant molten glass is caused to flow out to separate a molten glass mass, and the molten glass mass is formed into a preform in a cooling process of the molten glass mass.

A second method of producing the preform (referred to as a “preform production method II”) is a method in which the optical glass serving as a material is melted, the resultant molten glass is formed to produce a glass formed product, and the formed product is processed to obtain a preform.

The inclusion of a step of obtaining homogeneous molten glass from the optical glass serving as a material is common to both of the preform production methods I and II. This step can be performed by, for example, charging a melting vessel made of platinum with optical glass materials prepared through mixing such as to obtain the desired characteristics, performing heating, melting, refining, and homogenization to prepare homogenous molten glass, and causing this molten glass to flow out of an outflow nozzle or outflow pipe made of platinum or platinum alloy that has been temperature adjusted. Note that alternatively, rough melting of the optical glass materials may be performed to produce cullet, this cullet may be mixed and subjected to heating, melting, refining, and homogenization to obtain homogeneous molten glass, and the homogeneous molten glass may be caused to flow out from the outflow nozzle or outflow pipe.

In a situation in which a small preform or a spherical preform is to be produced, it is possible to adopt a method in which molten glass is caused to drop from an outflow nozzle as a molten glass drop of desired mass, this molten glass drop is received in a mold or the like, and the molten glass drop is formed into a preform, for example. Alternatively, a method in which a molten glass drop of desired mass is caused to drop from an outflow nozzle in the same manner into liquid nitrogen or the like so as to form the preform can be adopted.

On the other hand, in a situation in which a medium or large preform is to be produced, it is possible to adopt a method in which a molten glass flow is caused to flow downward through an outflow pipe, a leading part of the molten glass flow is received in a preform mold or the like, a constricted portion is formed between a nozzle of the molten glass flow and the preform mold, and then the preform mold is rapidly dropped directly downward so as to separate the molten glass flow at the constricted portion through surface tension of the molten glass and receive a molten glass mass of desired mass in a receiving member, thereby forming the molten glass mass into a preform, for example.

Note that in order to obtain a preform having a smooth surface without flaws, stains, wrinkles, surface deterioration, or the like (for example, a preform having a free surface), a method of applying wind pressure and causing levitation of a molten glass mass above a preform mold, or the like, while forming the molten glass mass into a preform or a method of loading a molten glass drop into a medium in which a substance that is a gas at normal temperature and normal pressure, such as liquid nitrogen, had been converted to a liquid by cooling and forming the molten glass drop into a preform, for example, may be adopted.

In a case in which a molten glass mass is formed into a preform while being levitated, gas (referred to as “levitation gas”) is blown against the molten glass mass such that upward wind pressure is applied to the molten glass mass. When the viscosity of the molten glass mass is too low in this case, the levitation gas may enter into the glass and may remain as bubbles in the preform. However, by setting the viscosity of the molten glass mass as 3 dPa·s to 60 dPa·s, it is possible to cause levitation of the glass mass without the levitation gas entering the glass.

The gas that is used when the levitation gas is blown against the preform may be air, N₂ gas, O₂ gas, Ar gas, He gas, water vapor, or the like. No specific limitations are placed on the wind pressure so long as it can cause levitation of the preform without the preform coming into contact with a solid such as the surface of a mold.

Since a precision press molded article (for example, an optical element) that is produced using the preform typically has an axis of rotational symmetry like a lens, it is desirable for the shape of the preform to also be a shape having an axis of rotational symmetry. Specific examples include a sphere and shapes that have one axis of rotational symmetry. The shape having one axis of rotational symmetry may be a shape that has a smooth contour without protrusions or recesses in a cross-section including the axis of rotational symmetry. For example, this shape may be a shape having, as a contour, an ellipse having a short axis that coincides with the axis of rotational symmetry in the aforementioned cross-section, or may be a shape resulting from flattening of a sphere (shape obtained when one axis passing through the center of a sphere is defined and a dimension in the direction of that axis is reduced).

Since forming in the preform production method I is performed in a temperature region where plastic deformation of the optical glass is possible, the preform may be obtained through press molding of the glass mass. In this case, the shape of the preform can be set comparatively freely, which makes it possible to set a shape that resembles the shape of a precision press molded article that is to be obtained. For example, one surface among opposite surfaces can be set as a convex shape and the other surface can be set as a concave shape, both surfaces can be set as concave surfaces, one surface can be set as a flat surface and the other surface can be set as a convex surface, one surface can be set as a flat surface and the other surface can be set as a concave surface, or both surfaces can be set as convex surfaces.

In the preform production method II, molten glass can be cast into and formed in a mold, strain in the formed product can subsequently be relieved by annealing, the formed product can be divided to desired dimensions and shape by cutting or cleaving to produce a plurality of glass pieces, and the glass pieces can be polished so as to smooth the surface and obtain preforms formed of glass of a specific mass. A preform that is produced in this manner is preferably used with the surface thereof covered by a carbon-containing film. The preform production method II is suitable for production of a spherical preform, a flat plate-like preform, or the like that can easily be ground and polished.

The following describes a preform that is more preferable in terms of further increasing mass producibility of a molded article such as an optical element by precision press molding.

In production of the preform of the present embodiment, reducing the amount of deformation of the glass in precision press molding makes it possible to lower the temperature of the glass and the mold during precision press molding, shorten the time required for press molding, reduce the pressing pressure, and so forth. This results in reduction of reactivity between the glass and a molding surface of the mold, reduction of the occurrence of defects during precision press molding, and further increased mass producibility.

In a situation in which a lens is to be produced through precision press molding of a preform, the preform is preferably a preform having opposite surfaces that are to be pressed (surfaces that are each pressed by an opposing molding surface of a mold during precision press molding), and is more preferably a preform that also has an axis of rotational symmetry passing through the centers of the two surfaces that are to be pressed. Of such preforms, a preform suitable for precision press molding of a meniscus lens is a preform for which one surface that is to be pressed is a convex surface and the other surface that is to be pressed is a concave surface, a flat surface, or a convex surface having a smaller curvature than the aforementioned convex surface.

Moreover, a suitable preform for precision press molding of a double concave lens is a preform for which one surface that is to be pressed is a convex surface, a concave surface, or a flat surface and the other surface that is to be pressed is a convex surface, a concave surface, or a flat surface.

On the other hand, a suitable preform for precision press molding of a double convex lens is a preform for which one surface that is to be pressed is a convex surface and the other surface that is to be pressed is a convex surface or a flat surface.

In any of these cases, it is preferable that the preform is a preform having a shape that resembles the shape of the precision press molded article.

Note that when a molten glass mass is formed into a preform using a preform mold, a lower surface of the glass on the mold is largely determined by the shape of a molding surface of the mold. On the other hand, an upper surface of the glass has a shape that is determined by the surface tension of the molten glass and the weight of the glass itself. In order to reduce the amount of deformation of the glass during precision press molding, it is also necessary to control the shape of the upper surface of the glass that is being formed in the preform mold. Although the shape of the upper surface of the glass becomes a convex free surface when the shape is determined by the surface tension of the molten glass and the weight of the glass itself, it is possible to make the upper surface a flat surface, a concave surface, or a convex surface having a smaller curvature than the aforementioned free surface by applying pressure to the upper surface of the glass. More specifically, the upper surface of the glass can be pressed using a mold having a molding surface with a desired shape or can be formed into a desired shape through application of wind pressure to the upper surface of the glass. Note that in a case in which the upper surface of the glass is pressed by a mold, a plurality of gas vents may be provided in a molding surface of the mold, gas may be spouted from these gas vents so as to form a gas cushion between the molding surface and the upper surface of the glass, and pressing of the upper surface of the glass may be performed via this gas cushion. Alternatively, in a case in which the upper surface of the glass is to be formed to obtain a surface having a larger curvature than the aforementioned free surface, forming of the upper surface of the glass may be performed by creating negative pressure in proximity to the upper surface so as to cause the upper surface to rise up.

Moreover, the preform is preferably a surface-polished preform in order to obtain a shape that more closely resembles the shape of the precision press molded article. For example, a preform where one of the surfaces to be pressed has been polished to obtain a flat surface or part of a spherical surface and the other of the surfaces to be pressed has been polished to obtain part of a spherical surface or a flat surface is preferable. The part of a spherical surface may be a convex surface or a concave surface, and it is desirable for a convex surface or a concave surface to be selected according to the shape of the precision press molded article as previously described.

Each of the preforms described above can preferably be used for molding a lens of 10 mm or more in diameter, and can more preferably be used for molding a lens of 20 mm or more in diameter. Moreover, each of these preforms can also preferably be used for molding a lens having a central thickness of more than 2 mm.

### (Optical Element)

The following provides a specific description of an optical element of one embodiment of the present disclosure (hereinafter, also referred to as the “optical element of the present embodiment”).

A feature of the optical element of the present embodiment is that the optical glass set forth above is used as a material. As a result of the optical glass set forth above being used as a material of the optical element of the present embodiment in this manner, the optical element of the present embodiment makes it possible to obtain a product having suppressed temperature dependence of image formation. Note that from a viewpoint of more reliably obtaining the desired performance, it is preferable that the optical element of the present embodiment satisfies the essential requirements relating to the composition of components that were previously described for the optical glass of the present embodiment, and more preferable that the optical element of the present embodiment satisfies the various preferable requirements that were previously described for the optical glass of the present embodiment.

Moreover, the optical element of the present embodiment is inclusive of an optical element for which the preform for precision press molding set forth above has been used.

Although no specific limitations are placed on the type of the optical element, representative examples include lenses such as aspheric lenses, spherical lenses, plano-concave lenses, plano-convex lenses, double concave lenses, double convex lenses, convex meniscus lenses, and concave meniscus lenses; microlenses; lens arrays; lenses with diffraction gratings; prisms; and prisms with lens functionality. Preferable examples of the optical element include lenses such as convex meniscus lenses, concave meniscus lenses, double convex lenses, double concave lenses, plano-convex lenses, and plano-concave lenses, prisms, and diffraction gratings. Each of the above-described lenses may be an aspheric lens or a spherical lens. An anti-reflection film, a partially reflecting film having wavelength selectivity, or the like may be provided at the surface as necessary.

### <Production Method of Optical Element>

Next, the production method of the optical element of the present embodiment is described.

The optical element of the present embodiment can be produced by precision press molding the preform set forth above using a press mold, for example.

The precision press molding can be performed using a press mold that has undergone high-accuracy processing of a molding surface in advance to obtain a desired shape, and a release film may be formed on the molding surface in order to prevent fusion of the glass during pressing and achieve good extension of the glass along the molding surface. The release film may be a film of a precious metal (platinum or platinum alloy), a film of an oxide (oxide of Si, Al, Zr, Y, etc.), a film of a nitride (nitride of B, Si, Al, etc.), or a carbon-containing film. The carbon-containing film is preferably a film having carbon as a main component (film in which the content of carbon is more than the content of other elements when the contents of elements in the film are expressed as atom %). Specifically, the carbon-containing film can, for example, be a carbon film or a hydrocarbon film. The method of film formation of the carbon-containing film may be a commonly known method such as vacuum vapor deposition, sputtering, or ion plating using a carbon material or may be a commonly known method such as thermal decomposition using a material gas such as a hydrocarbon. Other films can also be formed by vapor deposition, sputtering, ion platting, the sol-gel process, etc.

Heating of the press mold and the preform and a step of precision press molding are preferably performed in a non-oxidizing gas atmosphere such as nitrogen gas or a mixed gas of nitrogen gas and hydrogen gas in order to prevent oxidation of the molding surface of the press mold or a release film that can suitably be provided at the molding surface. In a non-oxidizing gas atmosphere, a release film covering the surface of the preform, and particularly a carbon-containing film is not oxidized and this film remains on the surface of a molded article obtained through the precision press molding. This film should ultimately be removed. Comparatively simple and complete removal of a release film such as a carbon-containing film can be performed through heating of the precision press molded article in an oxidizing atmosphere such as air. Removal of a release film such as a carbon-containing film should be performed at a temperature at which heating of the precision press molded article does not cause deformation thereof. Specifically, removal of a release film such as carbon-containing film is preferably performed in a temperature range that is lower than a transition temperature of the glass.

The production method of the optical element of the present embodiment may be either of the following two production methods, but is not specifically limited thereto. In production of the optical element of the present embodiment, the repetition of a step of precision press molding the preform for precision press molding set forth above using the same press mold is preferable from a viewpoint of mass production of the optical element.

A first method of producing the optical element (referred to as an “optical element production method I”) is a method in which the preform is introduced into a press mold and in which the preform and the press mold are heated together to perform precision press molding and obtain an optical element.

A second method of producing the optical element (referred to as an “optical element production method II”) is a method in which the preform is heated, is then introduced into a preheated press mold, and is precision press molded to obtain an optical element.

In the optical element production method I, the preform is supplied between a pair of upper and lower molds that face each other and that each have a molding surface that has undergone precise shape processing, the mold and the preform are both subsequently heated to a temperature corresponding to a glass viscosity of 10⁵ dPa·s to 10⁹ dPa·s so as to soften the preform, and then the preform is subjected to pressure forming, thereby enabling precise transfer of the shape of the molding surfaces of the molds to the glass. The optical element production method I is recommended when emphasis is placed on improvement of molding accuracy such as surface accuracy and eccentricity accuracy.

In the optical element production method II, the preform is heated in advance to a temperature corresponding to a glass viscosity of 10⁴ dPa·s to 10⁸ dPa·s, is subsequently supplied between a pair of upper and lower molds that face each other and that each have a molding surface that has undergone precise shape processing, and is subjected to pressure forming to thereby enable the precise transfer of the shape of the molding surfaces of the molds to the glass. The optical element production method II is recommended when emphasis is placed on improvement of productivity.

The pressure and time during pressing can be set as appropriate in consideration of the viscosity of the glass, etc. For example, the pressing pressure can be set as approximately 5 MPa to 15 MPa and the pressing time can be set as 10 seconds to 300 seconds. Pressing conditions such as pressing time and pressing pressure should be set as appropriate within commonly known ranges according to the shape and dimensions of the molded article.

The mold and the precision press molded article are subsequently cooled, and it is preferable that demolding and removal of the precision press molded article are performed once the temperature thereof reaches the strain point or lower. Note that annealing conditions of the molded article during cooling, such as the annealing rate, may be adjusted as appropriate in order that optical characteristics are accurately set to desired values.

It should be noted that the optical element of the present embodiment can be produced without undergoing a press molding step. For example, the optical element can be obtained by casting homogeneous molten glass into a mold to form a glass block, performing annealing to relieve strain while also performing adjustment of optical characteristics through adjustment of annealing conditions such that the refractive index of the glass is a desired value, subsequently performing cutting or cleaving of the glass block to produce glass pieces, and further performing grinding and polishing to perform finishing to obtain an optical element.

### EXAMPLES

The following provides a more specific description of the present disclosure through examples and comparative examples. However, the present disclosure is not limited to these examples.

Oxides, hydroxides, carbonates, and nitrates corresponding to respective components were prepared as materials for those components, were weighed out such that the composition after vitrification was as indicated in Tables 1 to 4, and were thoroughly mixed to obtain a batch. This batch was loaded into a platinum crucible and was melted in an electric furnace. Note that the temperature during melting was adjusted as appropriate within a range of 1000° C. to 1500° C. in order to promote sufficient bubble removal. Thereafter, stirring was performed in a timely manner to promote homogenization and perform refining, and then the resultant was cast into a mold that was preheated to an appropriate temperature. Next, slow cooling was performed inside of the electric furnace to yield an optical glass of each example or comparative example.

The obtained optical glass of each example or comparative example was then subjected to evaluation of devitrification resistance and measurement of refractive index (nd), Abbe number (vd), glass-transition temperature (Tg), and temperature coefficient of relative refractive index (dn/dT) according to procedures described below. The results are shown in Tables 1 to 4.

Evaluation of devitrification resistance was performed by visual evaluation of the glass after slow cooling with an evaluation of “A” given in a case in which devitrification was not observed and an evaluation of “B” given in a case in which devitrification was observed.

Note that in a case in which an evaluation of “B” was given for devitrification resistance, the quality of the optical glass was regarded as inadequate and the following measurements were not performed.

Measurements of the refractive index (nd) and Abbe number (vd) were performed according to a method described in JOGIS 01-2003 “Measuring method for refractive index of optical glass” of Japan Optical Glass Industry Standards.

Measurement of the glass-transition temperature (Tg) was performed according to a method described in JOGIS 08-2003 “Measuring method for thermal expansion of optical glass” of Japan Optical Glass Industry Standards.

Measurement of the temperature coefficient of relative refractive index (dn/dT) was performed using a d-line (587.562 nm) in a temperature range of 40° C. to 60° C. according to a method described in JOGIS 18-1994 “Measuring method for temperature coefficient of refractive index of optical glass” of Japan Optical Glass Industry Standards.

TABLE 1

| | | Exam- | Exam- | Exam- | Exam- | Exam- | Exam- | Exam- | Exam- | Exam- | Exam- |
|---|---|---|---|---|---|---|---|---|---|---|---|
| | | ple 1 | ple 2 | ple 3 | ple 4 | ple 5 | ple 6 | ple 7 | ple 8 | ple 9 | ple 10 |
| SiO₂ | [Mass %] | 10.80 | 9.50 | 12.00 | 7.00 | 12.00 | 6.00 | 7.00 | 7.40 | 9.00 | 5.00 |
| B₂O₃ | | 20.90 | 22.00 | 13.00 | 20.00 | 17.40 | 18.00 | 20.00 | 21.50 | 22.00 | 21.80 |
| Li₂O | | 4.00 | 3.30 | 4.00 | 4.00 | 4.00 | 4.00 | 4.00 | 3.90 | 4.00 | 3.70 |
| CaO | | 20.30 | 19.30 | 16.00 | 16.00 | 21.30 | 10.00 | 16.00 | 19.20 | 16.00 | 21.30 |
| BaO | | 6.00 | 6.40 | 8.00 | 8.00 | 7.80 | 8.00 | 8.00 | 7.50 | 8.00 | 2.20 |
| Nb₂O₅ | | 1.40 | 2.30 | 6.00 | 0.00 | 1.10 | 6.00 | 4.00 | 5.20 | 6.00 | 4.10 |
| ZrO₂ | | 0.60 | 1.20 | 2.00 | 4.00 | 3.80 | 6.00 | 4.00 | 0.80 | 4.00 | 4.70 |
| TiO₂ | | 2.80 | 1.50 | 0.00 | 2.00 | 1.70 | 1.00 | 1.00 | 0.50 | 1.00 | 1.80 |
| Y₂O₃ | | 2.20 | 7.10 | 3.00 | 4.00 | 1.40 | 3.00 | 4.00 | 2.00 | 8.00 | 6.60 |
| La₂O₃ | | 14.40 | 13.90 | 15.00 | 15.00 | 14.90 | 17.00 | 15.00 | 13.40 | 10.00 | 13.90 |
| Gd₂O₃ | | 6.60 | 9.40 | 10.00 | 11.00 | 10.60 | 12.00 | 11.00 | 10.60 | 0.00 | 9.30 |
| Ta₂O₅ | | 4.30 | 1.70 | 6.00 | 6.00 | 1.60 | 6.00 | 0.00 | 2.80 | 6.00 | 0.50 |
| WO₃ | | 5.70 | 2.40 | 5.00 | 3.00 | 2.40 | 3.00 | 6.00 | 5.20 | 6.00 | 5.10 |
| Total | | 100.00 | 100.00 | 100.00 | 100.00 | 100.00 | 100.00 | 100.00 | 100.00 | 100.00 | 100.00 |
| (Li₂O + CaO + BaO)/(SiO₂ + B₂O₃) | Molar ratio | 1.1 | 1.1 | 1.2 | 1.2 | 1.3 | 1.0 | 1.2 | 1.2 | 1.0 | 1.3 |

| | | | | | | | | | | |
|---|---|---|---|---|---|---|---|---|---|---|
| Devitrification resistance | A | A | A | A | A | A | A | A | A | A |
| Refractive index (nd) | 1.738 | 1.723 | 1.751 | 1.737 | 1.737 | 1.776 | 1.741 | 1.722 | 1.735 | 1.741 |
| Abbe number (νd) | 42.9 | 46.2 | 43.6 | 45.7 | 44.4 | 42.4 | 44.6 | 45.9 | 43.8 | 44.1 |
| Glass-transition temperature (Tg) [° C.] | 509 | 527 | 512 | 507 | 504 | 526 | 509 | 490 | 534 | 539 |
| Temperature coefficient of relative | 0.6 | 0.5 | 0.3 | 0.1 | 0.1 | 0.6 | 0.1 | 0.1 | 1.0 | 0.4 |
| refractive index [10⁻⁶° C.⁻¹] | | | | | | | | | | |

TABLE 2

| | | Exam- | Exam- | Exam- | Exam- | Exam- | Exam- | Exam- | Exam- | Exam- | Exam- | Exam- |
|---|---|---|---|---|---|---|---|---|---|---|---|---|
| | | ple 11 | ple 12 | ple 13 | ple 14 | ple 15 | ple 16 | ple 17 | ple 18 | ple 19 | ple 20 | ple 21 |
| SiO₂ | [Mass %] | 6.80 | 5.00 | 8.00 | 7.00 | 8.00 | 7.00 | 4.40 | 7.00 | 7.70 | 7.10 | 11.20 |
| B₂O₃ | | 19.50 | 21.80 | 20.00 | 20.00 | 21.00 | 20.00 | 21.60 | 20.00 | 19.70 | 18.60 | 18.30 |
| Li₂O | | 3.20 | 4.00 | 4.00 | 3.00 | 4.00 | 3.00 | 3.70 | 3.00 | 3.10 | 3.70 | 3.60 |
| CaO | | 17.10 | 19.30 | 17.00 | 16.00 | 24.00 | 16.00 | 22.50 | 16.00 | 19.30 | 15.90 | 22.60 |
| BaO | | 6.40 | 6.40 | 0.00 | 8.00 | 2.00 | 8.00 | 6.90 | 8.00 | 7.50 | 7.40 | 6.10 |
| Nb₂O₅ | | 1.10 | 2.40 | 4.00 | 6.00 | 2.00 | 6.00 | 0.00 | 6.00 | 1.50 | 4.20 | 0.50 |
| ZrO₂ | | 0.50 | 3.50 | 4.00 | 0.00 | 0.00 | 4.00 | 3.70 | 4.00 | 3.60 | 3.00 | 5.40 |
| TiO₂ | | 3.30 | 3.00 | 1.00 | 2.00 | 5.00 | 0.00 | 3.80 | 0.00 | 1.50 | 1.00 | 1.70 |
| Y₂O₃ | | 6.10 | 6.20 | 4.00 | 4.00 | 2.00 | 0.00 | 3.20 | 4.00 | 5.80 | 7.60 | 1.90 |
| La₂O₃ | | 15.80 | 10.80 | 16.00 | 15.00 | 12.00 | 15.00 | 11.60 | 15.00 | 13.60 | 16.00 | 15.00 |
| Gd₂O₃ | | 11.10 | 7.30 | 11.00 | 11.00 | 10.00 | 11.00 | 10.20 | 11.00 | 11.00 | 9.70 | 9.90 |
| Ta₂O₅ | | 3.40 | 5.00 | 6.00 | 6.00 | 5.00 | 6.00 | 4.00 | 6.00 | 5.00 | 4.90 | 2.60 |
| WO₃ | | 5.70 | 5.30 | 5.00 | 2.00 | 5.00 | 4.00 | 4.40 | 0.00 | 0.70 | 0.90 | 1.20 |
| Total | | 100.00 | 100.00 | 100.00 | 100.00 | 100.00 | 100.00 | 100.00 | 100.00 | 100.00 | 100.00 | 100.00 |
| (Li₂O + CaO + BaO)/ | Molar | 1.2 | 1.3 | 1.0 | 1.1 | 1.3 | 1.1 | 1.5 | 1.1 | 1.2 | 1.2 | 1.3 |
| (SiO₂ + B₂O₃) | ratio | | | | | | | | | | | |

| | | | | | | | | | | | |
|---|---|---|---|---|---|---|---|---|---|---|---|
| Devitrification resistance | A | A | A | A | A | A | A | A | A | A | A |
| Refractive index (nd) | 1.746 | 1.729 | 1.750 | 1.752 | 1.737 | 1.750 | 1.727 | 1.748 | 1.730 | 1.750 | 1.741 |
| Abbe number (νd) | 43.6 | 45.0 | 43.7 | 43.4 | 42.4 | 44.1 | 45.2 | 45.2 | 46.5 | 44.7 | 44.3 |
| Glass-transition temperature (Tg) [° C.] | 541 | 520 | 532 | 536 | 517 | 537 | 518 | 539 | 537 | 524 | 528 |
| Temperature coefficient of relative | 0.3 | 0.3 | 1.2 | 0.5 | 0.6 | 0.6 | −0.1 | 0.4 | 0.2 | 0.1 | 0.3 |
| refractive index [10⁻⁶° C.⁻¹] | | | | | | | | | | | |

TABLE 3

| | | Compar- | Compar- | Compar- | Compar- | Compar- | Compar- |
|---|---|---|---|---|---|---|---|
| | | ative | ative | ative | ative | ative | ative |
| | | Example 1 | Example 2 | Example 3 | Example 4 | Example 5 | Example 6 |
| SiO₂ | [Mass %] | 30.00 | 0.00 | 2.00 | 12.00 | 5.00 | 5.00 |
| B₂O₃ | | 13.00 | 22.00 | 40.00 | 5.00 | 21.00 | 20.00 |
| Li₂O | | 4.00 | 2.00 | 3.00 | 3.00 | 0.00 | 8.00 |
| CaO | | 22.00 | 16.00 | 20.00 | 18.00 | 16.00 | 20.00 |
| BaO | | 8.00 | 8.00 | 8.00 | 8.00 | 8.00 | 8.00 |
| Nb₂O₅ | | 0.00 | 5.00 | 0.00 | 5.00 | 4.00 | 3.00 |
| ZrO₂ | | 0.00 | 2.00 | 0.00 | 5.00 | 4.00 | 0.00 |
| TiO₂ | | 0.00 | 5.00 | 0.00 | 5.00 | 4.00 | 1.00 |
| Y₂O₃ | | 0.00 | 3.00 | 0.00 | 8.00 | 5.00 | 5.00 |
| La₂O₃ | | 15.00 | 15.00 | 15.00 | 16.00 | 16.00 | 16.00 |
| Gd₂O₃ | | 5.00 | 11.00 | 12.00 | 9.00 | 8.00 | 8.00 |
| Ta₂O₅ | | 3.00 | 6.00 | 0.00 | 6.00 | 6.00 | 6.00 |
| WO₃ | | 0.00 | 5.00 | 0.00 | 0.00 | 3.00 | 0.00 |
| ZnO | | 0.00 | 0.00 | 0.00 | 0.00 | 0.00 | 0.00 |
| Total | | 100.00 | 100.00 | 100.00 | 100.00 | 100.00 | 100.00 |
| (Li₂O + CaO + BaO)/ | Molar | 1.4 | 1.3 | 0.8 | 1.7 | 0.9 | 1.8 |
| (SiO₂ + B₂O₃) | ratio | | | | | | |

| | | | | | | |
|---|---|---|---|---|---|---|
| Devitrification resistance | A | B | A | B | A | B |
| Refractive index (nd) | 1.671 | — | 1.671 | — | 1.784 | — |
| Abbe number (νd) | 53.8 | | 56.0 | | 40.6 | |
| Glass-transition temperature (Tg) [° C.] | 552 | | 544 | | 642 | |
| Temperature coefficient of relative | 1.4 | | 0.3 | | 1.6 | |
| refractive index [10⁻⁶° C.⁻¹] | | | | | | |

| | | Compar- | Compar- | Compar- | Compar- |
|---|---|---|---|---|---|
| | | ative | ative | ative | ative |
| | | Example 7 | Example 8 | Example 9 | Example 10 |
| SiO₂ | [Mass %] | 5.00 | 10.00 | 5.00 | 7.00 |
| B₂O₃ | | 15.00 | 20.00 | 20.00 | 20.00 |
| Li₂O | | 4.00 | 3.00 | 3.00 | 3.50 |
| CaO | | 3.00 | 40.00 | 15.00 | 16.00 |
| BaO | | 10.00 | 0.00 | 20.00 | 7.50 |
| Nb₂O₅ | | 8.00 | 0.00 | 0.00 | 20.00 |
| ZrO₂ | | 8.00 | 0.00 | 4.00 | 0.00 |
| TiO₂ | | 7.00 | 0.00 | 0.00 | 0.00 |
| Y₂O₃ | | 8.00 | 0.00 | 6.00 | 0.00 |
| La₂O₃ | | 17.00 | 16.00 | 16.00 | 16.00 |
| Gd₂O₃ | | 8.00 | 8.00 | 11.00 | 10.00 |
| Ta₂O₅ | | 7.00 | 3.00 | 0.00 | 0.00 |
| WO₃ | | 0.00 | 0.00 | 0.00 | 0.00 |
| ZnO | | 0.00 | 0.00 | 0.00 | 0.00 |
| Total | | 100.00 | 100.00 | 100.00 | 100.00 |
| (Li₂O + CaO + BaO)/ | Molar | 0.9 | 1.8 | 1.4 | 1.1 |
| (SiO₂ + B₂O₃) | ratio | | | | |

| | | | | |
|---|---|---|---|---|
| Devitrification resistance | B | B | B | A |
| Refractive index (nd) | — | — | — | 1.803 |
| Abbe number (νd) | | | | 38.8 |
| Glass-transition temperature (Tg) [° C.] | | | | 530 |
| Temperature coefficient of relative | | | | 0.6 |
| refractive index [10⁻⁶° C.⁻¹] | | | | |

TABLE 4

| | | Compar- | Compar- | Compar- | Compar- | Compar- | Compar- |
|---|---|---|---|---|---|---|---|
| | | ative | ative | ative | ative | ative | ative |
| | | Example 11 | Example 12 | Example 13 | Example 14 | Example 15 | Example 16 |
| SiO₂ | [Mass %] | 5.00 | 5.00 | 5.00 | 6.00 | 5.00 | 5.00 |
| B₂O₃ | | 20.00 | 20.00 | 20.00 | 21.00 | 20.00 | 20.00 |
| Li₂O | | 3.00 | 3.00 | 3.00 | 3.00 | 3.00 | 3.00 |
| CaO | | 20.00 | 20.00 | 20.00 | 16.00 | 20.00 | 20.00 |
| BaO | | 8.00 | 8.00 | 8.00 | 8.00 | 8.00 | 8.00 |
| Nb₂O₅ | | 0.00 | 0.00 | 0.00 | 5.00 | 0.00 | 2.00 |
| ZrO₂ | | 20.00 | 0.00 | 0.00 | 5.00 | 4.00 | 0.00 |
| TiO₂ | | 0.00 | 20.00 | 0.00 | 5.00 | 0.00 | 0.00 |
| Y₂O₃ | | 0.00 | 0.00 | 20.00 | 5.00 | 0.00 | 0.00 |
| La₂O₃ | | 16.00 | 16.00 | 16.00 | 2.00 | 40.00 | 12.00 |
| Gd₂O₃ | | 8.00 | 8.00 | 8.00 | 12.00 | 0.00 | 30.00 |
| Ta₂O₅ | | 0.00 | 0.00 | 0.00 | 6.00 | 0.00 | 0.00 |
| WO₃ | | 0.00 | 0.00 | 0.00 | 6.00 | 0.00 | 0.00 |
| ZnO | | 0.00 | 0.00 | 0.00 | 0.00 | 0.00 | 0.00 |
| Total | | 100.00 | 100.00 | 100.00 | 100.00 | 100.00 | 100.00 |
| (Li₂O + CaO + BaO)/ | Molar | 1.4 | 1.4 | 1.4 | 1.1 | 1.4 | 1.4 |
| (SiO₂ + B₂O₃) | ratio | | | | | | |

| Devitrification resistance | | B | B | B | A | B | B |
|---|---|---|---|---|---|---|---|
| Refractive index (nd) | | — | — | — | 1.770 | — | — |
| Abbe number (νd) | | | | | 37.3 | | |
| Glass-transition temperature (Tg) [° C.] | | | | | 547 | | |
| Temperature coefficient of relative | | | | | 1.4 | | |
| refractive index [10⁻⁶° C.⁻¹] | | | | | | | |
| | | | Compar- | Compar- | Compar- | Compar- | Compar- |
| | | | ative | ative | ative | ative | ative |
| | | | Example 17 | Example 18 | Example 19 | Example 20 | Example 21 |
| | SiO₂ | [Mass %] | 5.00 | 5.00 | 2.00 | 12.00 | 8.00 |
| | B₂O₃ | | 20.00 | 20.00 | 15.00 | 22.00 | 20.00 |
| | Li₂O | | 3.00 | 3.00 | 4.00 | 1.00 | 2.00 |
| | CaO | | 20.00 | 20.00 | 22.00 | 13.00 | 15.00 |
| | BaO | | 8.00 | 8.00 | 8.00 | 0.00 | 0.00 |
| | Nb₂O₅ | | 0.00 | 0.00 | 4.00 | 6.00 | 4.00 |
| | ZrO₂ | | 0.00 | 0.00 | 5.00 | 5.00 | 4.00 |
| | TiO₂ | | 0.00 | 0.00 | 5.00 | 2.00 | 5.00 |
| | Y₂O₃ | | 0.00 | 0.00 | 4.00 | 3.00 | 0.00 |
| | La₂O₃ | | 16.00 | 16.00 | 16.00 | 16.00 | 15.00 |
| | Gd₂O₃ | | 8.00 | 8.00 | 10.00 | 8.00 | 9.00 |
| | Ta₂O₅ | | 20.00 | 0.00 | 5.00 | 6.00 | 4.00 |
| | WO₃ | | 0.00 | 20.00 | 0.00 | 6.00 | 4.00 |
| | ZnO | | 0.00 | 0.00 | 0.00 | 0.00 | 10.00 |
| | Total | | 100.00 | 100.00 | 100.00 | 100.00 | 100.00 |
| | (Li₂O + CaO + BaO)/ | Molar | 1.4 | 1.4 | 2.3 | 0.5 | 0.8 |
| | (SiO₂ + B₂O₃) | ratio | | | | | |

| | | | | | |
|---|---|---|---|---|---|
| Devitrification resistance | B | B | B | A | A |
| Refractive index (nd) | — | — | — | 1.756 | 1.777 |
| Abbe number (νd) | | | | 42.0 | 40.0 |
| Glass-transition temperature (Tg) [° C.] | | | | 625 | 547 |
| Temperature coefficient of relative | | | | 4.0 | 4.0 |
| refractive index [10⁻⁶° C.⁻¹] | | | | | |

It can be seen from Table 1 and Table 2 that the optical glasses of Examples 1 to 21 each have a refractive index (nd) of not less than 1.70 and not more than 1.80 and an Abbe number (vd) of not less than 40 and not more than 55, and thus, in other words, have a high refractive index and low dispersion. Moreover, the optical glasses of Examples 1 to 21 each have a temperature coefficient of relative refractive index of not less than −5.0×10⁻⁶° C.⁻¹ and not more than 3.0×10⁻⁶° C.⁻¹ and have significantly suppressed temperature dependence of image formation.

Furthermore, the optical glasses of Examples 1 to 21 each have a glass-transition temperature (Tg) of 560° C. or lower, and thus have a low softening temperature and can more easily be precision press molded.

In contrast, it can be seen from Table 3 that the optical glass of Comparative Example 1 had a refractive index of lower than 1.70. This may be due to excessive SiO₂, for example.

In Comparative Example 2, devitrification occurred and good quality glass could not be obtained. This may be due to insufficient SiO₂, for example.

The optical glass of Comparative Example 3 had a refractive index of lower than 1.70. This may be due to excessive B₂O₃, for example.

In Comparative Example 4, devitrification occurred and good quality glass could not be obtained. This may be due to insufficient B₂O₃, for example.

The optical glass of Comparative Example 5 had a glass-transition temperature (Tg) of higher than 560° C. This may be due to insufficient Li₂O, for example.

In Comparative Example 6, devitrification occurred and good quality glass could not be obtained. This may be due to excessive Li₂O, for example.

In Comparative Example 7, devitrification occurred and good quality glass could not be obtained. This may be due to insufficient CaO, for example. In Comparative Example 8, devitrification occurred and good quality glass could not be obtained. This may be due to excessive CaO, for example.

In Comparative Example 9, devitrification occurred and good quality glass could not be obtained. This may be due to excessive BaO, for example.

The optical glass of Comparative Example 10 had a refractive index (nd) of higher than 1.80 and an Abbe number of lower than 40. This may be due to excessive Nb₂O₅, for example.

Moreover, it can be seen from Table 4 that in Comparative Example 11, devitrification occurred and good quality glass could not be obtained. This may be due to excessive ZrO₂, for example.

In Comparative Example 12, devitrification occurred and good quality glass could not be obtained. This may be due to excessive TiO₂, for example.

In Comparative Example 13, devitrification occurred and good quality glass could not be obtained. This may be due to excessive Y₂O₃, for example.

The optical glass of Comparative Example 14 had an Abbe number of lower than 40. This may be due to insufficient La₂O₃, for example. More specifically, the amounts of components that contribute to increasing the refractive index (BaO, Nb₂O₅, ZrO₂, TiO₂, etc.) were increased in order to compensate for the fact that insufficient La₂O₃ may result in insufficient raising of the refractive index, and, as a consequence, it was not possible to keep the Abbe number within a specific range.

In Comparative Example 15, devitrification occurred and good quality glass could not be obtained. This may be due to excessive La₂O₃, for example.

In Comparative Example 16, devitrification occurred and good quality glass could not be obtained. This may be due to excessive Gd₂O₃, for example. In Comparative Example 17, devitrification occurred and good quality glass could not be obtained. This may be due to excessive Ta₂O₅, for example.

In Comparative Example 18, devitrification occurred and good quality glass could not be obtained. This may be due to excessive WO₃, for example.

In Comparative Example 19, devitrification occurred and good quality glass could not be obtained. This may be due to the R/F ratio being larger than 2.0, for example.

The optical glass of Comparative Example 20 had a temperature coefficient of relative refractive index of larger than 3.0×10⁻⁶° C.⁻¹ and a glass-transition temperature (Tg) of higher than 560° C. This may be due to R/F (molar ratio) being smaller than 0.8, for example.

The optical glass of Comparative Example 21 had a temperature coefficient of relative refractive index of larger than 3.0×10⁻⁶° C.⁻¹. This may be due to the inclusion of ZnO, for example.

### INDUSTRIAL APPLICABILITY

According to the present disclosure, it is possible to provide an optical glass that in addition to having a high refractive index and low dispersion, also has a low glass-transition temperature and can suppress temperature dependence of image formation. Moreover, according to the present disclosure, it is possible to provide a preform for precision press molding and an optical element in which the aforementioned optical glass is used.

1. An optical glass comprising a composition containing, by mass %:
not less than 1% and not more than 15% of SiO₂;
not less than 10% and not more than 25% of B₂O₃;
not less than 1% and not more than 5% of Li₂O;
not less than 5% and not more than 30% of CaO;
not less than 0% and not more than 10% of BaO;
not less than 0% and not more than 8% of Nb₂O₅;
not less than 0% and not more than 8% of ZrO₂;
not less than 0% and not more than 8% of TiO₂;
not less than 0% and not more than 10% of Y₂O₃;
not less than 5% and not more than 20% of La₂O₃;
not less than 0% and not more than 15% of Gd₂O₃;
not less than 0% and not more than 8% of Ta₂O₅; and
not less than 0% and not more than 8% of WO₃, wherein
the optical glass does not substantially contain ZnO,
R/F, where R is total content in mol % of Li₂O, CaO, and BaO and F is total content in mol % of SiO₂ and B₂O₃, is not less than 0.8 and not more than 2.0, and
a temperature coefficient of relative refractive index at a d-line of 587.562 nm for from 40° C. to 60° C. is not less than −5.0×10⁻⁶° C.⁻¹ and not more than 3.0×10⁻⁶° C.⁻¹.

2. The optical glass according to claim 1, having a refractive index (nd) of not less than 1.70 and not more than 1.80 and an Abbe number (vd) of not less than 40 and not more than 55.

3. The optical glass according to claim 1, having a glass-transition temperature (Tg) of 560° C. or lower.

4. A preform for precision press molding comprising, as a material, the optical glass according to claim 1.

5. An optical element comprising, as a material, the optical glass according to claim 1.

6. The optical glass according to claim 2, having a glass-transition temperature (Tg) of 560° C. or lower.

7. A preform for precision press molding comprising, as a material, the optical glass according to claim 2.

8. An optical element comprising, as a material, the optical glass according to claim 2.

9. A preform for precision press molding comprising, as a material, the optical glass according to claim 3.

10. An optical element comprising, as a material, the optical glass according to claim 3.

11. A preform for precision press molding comprising, as a material, the optical glass according to claim 6.

12. An optical element comprising, as a material, the optical glass according to claim 6.
